(19) United States
(12) Patent Application Publication
(10) Pub. No.: US 2012/0263059 A1
(43) Pub. Date: Oct. 18, 2012

(54) MOBILE TERMINAL, WIRELESS NETWORK SYSTEM HAVING THE MOBILE TERMINAL, AND SCANNING METHOD OF THE WIRELESS NETWORK SYSTEM

(75) Inventors: Myung Chul KIM, Daejeon (KR); Soo Yong Lee, Daejeon (KR)

(73) Assignee: KOREA ADVANCED INSTITUTE OF SCIENCE AND TECHNOLOGY, Daejeon (KR)

(21) Appl. No.: 13/447,044

(22) Filed: Apr. 13, 2012

(30) Foreign Application Priority Data
Apr. 14, 2011 (KR) 10-2011-0034759

(51) Int. Cl. H04W 24/00

(52) U.S. Cl. 370/252

(57) ABSTRACT

A mobile terminal includes an acceleration sensor, and a wireless network system includes the mobile terminal including a sensor for generating a signal corresponding to a movement of the mobile terminal; a status management module for detecting a moving status of the mobile terminal by using the signal from the sensor, and for sensing a strength of a signal provided from a base station to which the mobile terminal is connected; a scanning module for performing a scanning operation with respect to adjacent base stations according to a result of the detecting and a result of the sensing; and a memory for storing information collected via the scanning operation.

### CROSS-REFERENCE TO RELATED PATENT APPLICATION

This application claims the benefit of Korean Patent Application No. 10-2011-0034759, filed on Apr. 14, 2011, in the Korean Intellectual Property Office, the disclosure of which is incorporated herein in its entirety by reference.

### BACKGROUND OF THE INVENTION

1. Field of the Invention

The present invention relates to a mobile terminal and a wireless network system including the mobile terminal, and more particularly, to a mobile terminal that uses a decreased number of attempts to perform scanning for connecting to a wireless network, a wireless network system including the mobile terminal, and a scanning method of the wireless network system.

2. Description of the Related Art

Recently, due to increased use of mobile terminals such as smart phones, tablet personal computers (PCs), or the like, many access points or base stations have been deployed in limited areas such as university campuses, offices, airports, stores in urban areas, or the like. In a wireless network environment, when a mobile terminal moves out of the coverage of a wireless access point (hereinafter, referred to as a ‘base station’) to which the mobile terminal is currently connected, the mobile terminal performs a handoff process so as to access another base station. While the mobile terminal is communicating with a currently-connected base station, in order to minimize a delay time due to the handoff process, the mobile terminal periodically performs a scanning operation so as to collect information regarding channel, data transmission rate, signal strength, or the like of an available base station around the mobile terminal.

The mobile terminal periodically performs the scanning operation by sequentially switching it wireless interface to all available channels of, and thus, during the scanning operation, the mobile terminal cannot perform general data communication. In this regard, when a period of the scanning operation is too short, although the mobile terminal is in a still status, i.e., although wireless network information around the mobile terminal is not changed, the scanning operation is continually performed, and thus, resources of a wireless network are unnecessarily wasted and a battery efficiency of the mobile terminal is decreased by consuming power for the scanning operation. On the other hand, when the period of the scanning operation is too long, the mobile terminal recognizes too late a change in an adjacent wireless network environment, and thus, the handoff process is not efficiently performed. Accordingly, the mobile terminal cannot seamlessly perform data communication.

According to the IEEE 802.11 wireless local area network (LAN) standard, the scanning operation of the mobile terminal may be divided into an active scanning operation and a passive scanning operation. In the active scanning operation, the mobile terminal transmits a broadcast-type probe request to base stations, and an adjacent base station that receives the probe request transmit a probe response back to the mobile terminal, so that the mobile terminal collects information regarding the base stations. On the other hand, in the passive scanning operation, the mobile terminal receives a beacon frame that is periodically broadcasted from each base station via each channel, and compared to the active scanning operation, the passive scanning operation requires a longer time.

Thus, most of mobile terminals that have been recently released obtain adjacent network information (or adjacent base station information) by using the active scanning operation. According to a background scanning operation that is periodically performed by the mobile terminal, because a management frame is exchanged with an adjacent network in every available wireless channel, when network congestion increases, a bigger network overhead occurs, and thus, data communication of all wireless channels scanned by the mobile terminal is severely disrupted. Accordingly, a function of an entire wireless network system deteriorates.

In order to solve the aforementioned problems, many methods have been presented to adaptively perform a scanning operation by using a signal strength with respect to base stations around the mobile terminal, a data throughput, a delay time, and a packet loss rate of a channel that currently performs communication. However, the presented methods cannot determine an actual movement of the mobile terminal, and thus, a scanning operation is unnecessarily performed although the mobile terminal is in a still status. In order to detect a movement of the mobile terminal, a scanning method that uses a global positioning system (GPS) is performed only when a user position is changed. However, position detection using the GPS is only available in an outdoor area and is not available in an indoor area. Also, in order to detect a change in the user position, the mobile terminal has to stay in contact with the GPS, which requires power consumption two or three times greater than power consumption during a network scanning operation, and thus, a battery efficiency of the mobile terminal is considerably decreased.

### SUMMARY OF THE INVENTION

The present invention provides a mobile terminal, a wireless network system including the mobile terminal, and a scanning method used by the wireless network system, whereby a network overhead problem or an increase of power consumption in the mobile terminal, which occurs during an unnecessary scanning operation performed in the wireless network system, may be decreased.

According to an aspect of the present invention, there is provided a scanning method performed by a wireless network system comprising a mobile terminal, the scanning method including operations of detecting a moving status of the mobile terminal by using a value of a signal from a sensor that is equipped in the mobile terminal; determining whether the moving status of the mobile terminal is maintained during the first time period after the moving status is detected; sensing a strength of a signal provided from a base station to which the mobile terminal is connected; and performing a scanning operation according to a result of the operation of determining and a result of the operation of sensing.

The scanning method may further include an operation of determining whether a decrease status of the strength of the signal provided from the base station is maintained during the first time period, and when it is determined that the moving status of the mobile terminal is maintained and simultaneously it is determined that the decrease status of the strength of the signal provided from the base station is maintained during the first time period, the scanning operation may be performed.

The operation of determining the moving status may include an operation of determining whether the mobile terminal becomes distant from the base station, based on the sensing of the strength of the signal provided from the base station, and when the mobile terminal becomes distant from the base station, the scanning operation may be performed.

The scanning method may further include operations of storing information regarding a result of the scanning operation in a memory in the mobile terminal; comparing the strength of the signal provided from the base station with a threshold value; and performing a handoff process with respect to other base stations, according to a comparison result.

The handoff process may be performed when the moving status of the mobile terminal is maintained and simultaneously the strength of the signal is less than the threshold value.

According to another aspect of the present invention, there is provided a mobile terminal including a sensor for generating a signal corresponding to movement of the mobile terminal; a status management module for detecting a moving status of the mobile terminal by using the signal from the sensor, and for sensing a strength of a signal provided from a base station to which the mobile terminal is connected; a scanning module for performing a scanning operation with respect to adjacent base stations according to a result of the detecting and a result of the sensing; and a memory for storing information collected via the scanning operation.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an example of a scanning method used by a wireless network system according to an embodiment of the present invention;

FIG. 2 illustrates configuration of a network where a wireless network scanning method is applied, according to an embodiment of the present invention;

FIG. 3 is a diagram illustrating all processes of a scanning operation performed by a wireless network system, according to an embodiment of the present invention;

FIG. 4 is a block diagram of a mobile terminal included in a wireless network system, according to an embodiment of the present invention;

FIG. 5 is a block diagram illustrating a detailed structure of the mobile terminal of FIG. 4;

FIG. 6 is a flowchart of a scanning method performed by a wireless network system, according to an embodiment of the present invention;

FIG. 7 is a flowchart of a scanning method performed by a wireless network system, according to another embodiment of the present invention; and

FIG. 8 is a flowchart of a scanning method performed by a wireless network system, according to another embodiment of the present invention.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

As used herein, the term “and/or” includes any and all combinations of one or more of the associated listed items.

Also, when a part “includes” or “comprises” an element, unless there is a particular description contrary thereto, the part can further include other elements, not excluding the other elements. In the following description, terms such as “unit” and “block” indicate a unit for processing at least one function or operation, wherein the unit and the block may be embodied as hardware or software or embodied by combining hardware and software.

The term “mobile terminal” collectively indicates devices having at least one wireless interface mounted therein and capable of receiving a communication service by accessing a wireless network such as LTE, 3G, WiMAX, WiBro, a wireless local area network (WLAN), or the like. That is, the mobile terminal collectively includes mobile phones, smart phones, smart tablet PCs, notebooks, personal digital assistants (PDAs), portable multimedia players (PMPs), and the like that may exchange a signal with a Point of Attachment (PoA) that is a wireless access point so as to access the wireless network and may perform a scanning operation so as to search for an available wireless network. However, examples of the mobile terminal are not limited to the aforementioned devices.

The wireless access point, i.e., the “PoA”, indicates a device that directly performs communication with the mobile terminal so as to allow the mobile terminal to access the wireless network and that is connected to a wired network for connection to Internet. For example, the wireless access point collectively indicates an access point (AP) of a WLAN, a radio access station (RAS) of WiBro or WiMAX, a base station of a cellular network, and the like. Hereinafter, the wireless access point is referred to as a “base station”, and the base station includes the aforementioned various types of the wireless access point.

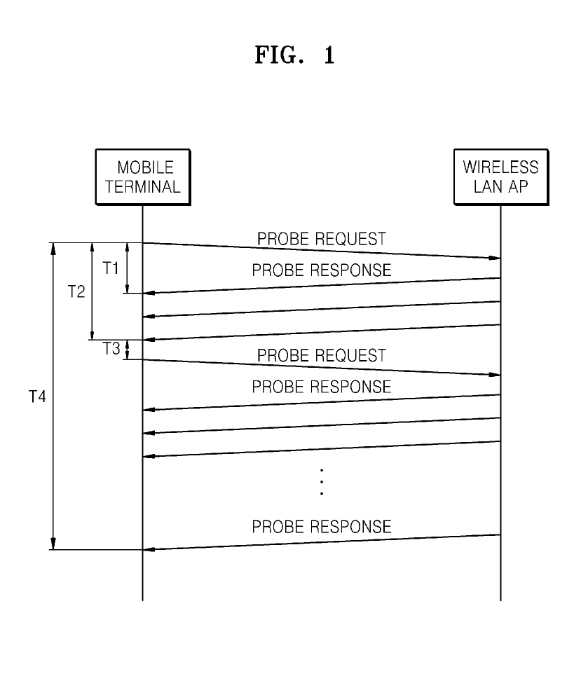

FIG. 1 illustrates an example of a scanning method used by a wireless network system according to an embodiment of the present invention. In the example of FIG. 1, it is assumed that the scanning method is performed to search for a WLAN network. As illustrated in FIG. 1, a mobile terminal transmits a broadcast-type probe request via each channel so as to collect WLAN AP information around the mobile terminal. Here, in general, a WLAN AP having the greatest signal strength firstly transmits a probe response to the mobile terminal, and a time T1 between the probe request and the probe response is defined as a minimum channel time according to the IEEE 802.11 standard. Also, a time T2 when the mobile terminal receives a final probe response is defined as a maximum channel time. The time T1 and the time T2 may be set by manufacturers.

When traffic is not heavy in a wireless network channel, although the time T1 and the time T2 are set to be equal to or less than several milliseconds through 20 milliseconds, the mobile terminal may receive all probe responses from adjacent WLAN APs without problems. However, when a network congestion frequently occurs, like in a dense region, the mobile terminal may receive all probe response frames from the adjacent WLAN APs only when the value of the time T2 is set as 40 through 50 milliseconds. This corresponds to only one channel, and a time of T2+T3 including a time T3 when the mobile terminal changes a channel of the wireless interface means a time taken to scan one channel. In this regard, a time T4, which indicates a time taken to scan all of 11 channels in a 2.4 GHz broadband that is mainly used by the mobile terminal, is increased to at least several hundreds of milliseconds.

In an aspect in which the mobile terminal and base stations exchange a management frame for each channel, the aforementioned wireless network scanning process is similar to a case in which different types of wireless networks such as 3G, WiBro, or the like are searched for. Thus, a background scanning operation that is periodically performed via the aforementioned wireless network scanning process so as to support rapid mobility of the mobile terminal causes a considerable network overhead, so that it is necessary to minimize a number of times that the background scanning operation is performed, by performing a scanning operation only when it is required.

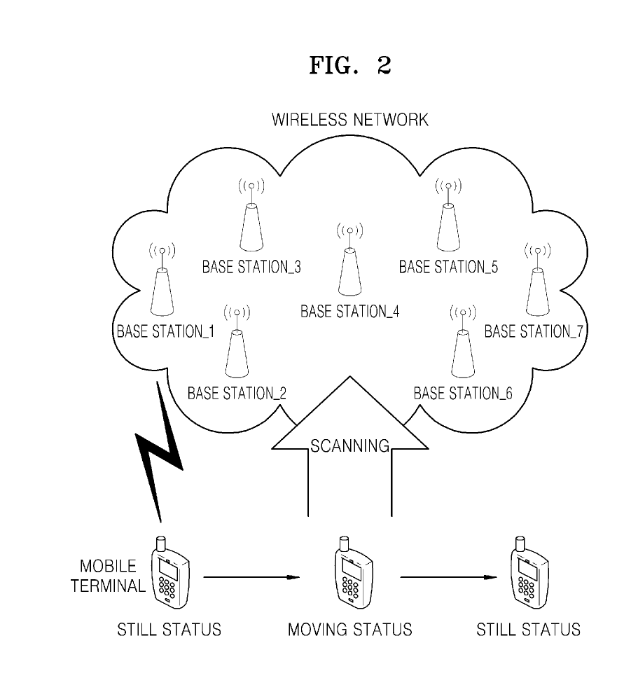

FIG. 2 illustrates configuration of a network where a wireless network scanning method is applied, according to an embodiment of the present invention. A wireless network of FIG. 2 may include a plurality of base stations (a base station_1 through a base station_7), and channel frequencies and Internet protocol (IP) sub-nets that are used by the base stations may be partially different. In the wireless network of FIG. 2, when a mobile terminal of a user moves while the mobile terminal initially accesses the base station_1 and performs data communication, values of X, Y, and Z-axes of an acceleration sensor (not shown) that is mounted in the mobile terminal are changed. In this manner, the values of the acceleration sensor are changed to values that specify a moving status, and when a similar pattern continues for a predetermined time period, the acceleration sensor determines that the mobile terminal is in the moving status, and at that time, a scanning operation is performed to search for a changed adjacent wireless network environment. Here, it is also required to measure a strength of a signal transmitted from the base station_1 to which the mobile terminal is currently connected, and the measurement is used as a reference so as to determine whether the mobile terminal moves toward the base station_1 or becomes distant from the base station_1. That is, although the movement of the mobile terminal is detected, if it is not required to search for a new adjacent base station, the mobile terminal does not perform an unnecessary scanning operation.

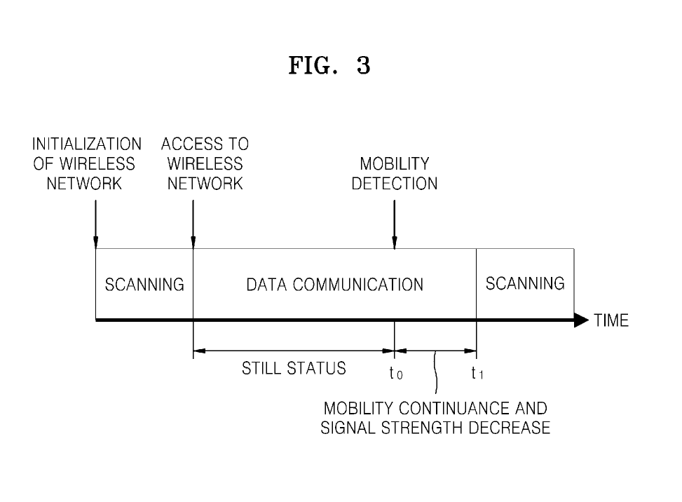

FIG. 3 is a diagram illustrating all processes of a scanning operation performed by a wireless network system, according to an embodiment of the present invention. When a wireless interface of the mobile terminal is initialized, in order to access a wireless network for data communication, the mobile terminal performs the scanning operation so as to search for the wireless network via a process described with referenced to FIG. 1. When information regarding base stations of adjacent wireless networks is obtained after the scanning operation is ended, the mobile terminal selects an optimal base station according to specific standards including a signal strength, an available bandwidth, or the like of the searched base stations, and performs a specific process for an access. Here, the access to the base station is performed according to protocols defined in the wireless network standard used by the mobile terminal.

After the access to the selected base station is performed, when the mobile terminal performs data communication with the wireless network, the acceleration sensor of the mobile terminal constantly senses a moving status of the mobile terminal. Here, the axial values (along X, Y, and Z-axes) of the acceleration sensor are constantly changed according to the moving status of the mobile terminal. The acceleration sensor analyzes a maintenance pattern of the changed values, and determines whether the changed values indicate a still status or the moving status of the mobile terminal. If the acceleration sensor determines that the mobile terminal is in the still status, base station information that is collected via the initial scanning operation to search for the wireless network is almost constant so that it is not required to periodically perform a scanning operation.

When the acceleration sensor determines the moving status of the mobile terminal, the axial values (X, Y, and Z-axes) of the acceleration sensor may be sampled at regular intervals, a standard deviation value or a variance value may be calculated from the axial values (X, Y, and Z-axes), and then, the acceleration sensor may determine the moving status of the mobile terminal by using the calculation result. Table 1 shows an example of sampled values of the axes (X, Y, and Z-axes) of the acceleration sensor.

TABLE 1

| state | [symbol] | [symbol] | [symbol] | sum |
|---|---|---|---|---|
| Still | 0.042 | 0.032 | 0.039 | 0.113 |
| moving | 0.142 | 0.134 | 0.153 | 0.429 |

The values [symbol] , [symbol] , [symbol] of Table 1 indicate standard deviation values with respect to the X, Y, and Z-axes, and the moving status of the mobile terminal may be determined according to the sum of the standard deviation values with respect to the X, Y, and Z-axes. For example, when the sum of the standard deviation values is less than 0.113, the acceleration sensor may determine that the mobile terminal is in the still status, and when the sum of the standard deviation values is equal to or greater than 0.429, the acceleration sensor may determine that the mobile terminal is in the moving status. As a reference to divide the still status and the moving status, a value between 0.113 and 0.429 may be used as a threshold value of the determination reference. If the variance values with respect to the X, Y, and Z-axes are used as the determination reference, another calculation result of the variance values may be used or another threshold value may be used to determine a status of the mobile terminal.

On the other hand, when a change in signal values of the acceleration sensor in data communication indicates a pattern of the moving status, the acceleration sensor senses whether the pattern of the moving status is constantly maintained during a predetermined time period starting from a time to. Also, as described above, in order to determine necessity with respect to searching for new adjacent base stations, the mobile terminal also senses a strength of a signal during the same time period, wherein the signal is transmitted from a base station to which the mobile terminal is currently connected. If the pattern of the signal values of the acceleration sensor is maintained in the moving status during a predetermined sensing time period t1 through t0, and the strength of the signal of the currently-connected base station is decreased, the mobile terminal determines that it is necessary to update information regarding the new adjacent base stations, and performs a scanning operation at the time t1 so as to search for new base stations. According to a result of the scanning operation, information regarding base stations around the mobile terminal may be updated and the updated information may be used in a handoff process for an access to a new base station. The predetermined sensing time period t1 through t0 may not be a fixed value but may be changed to a time period until a strength of a signal transmitted from a connected base station is decreased to a value equal to or less than a threshold value at which data communication may not be smoothly performed.

The fact that the mobile terminal maintains its moving status during a predetermined time period does not mean that the mobile terminal moves in all sections of the predetermined time period. For example, when a predetermined time period t1 through t0 is set, and it is determined that the mobile terminal is further distant from a currently-connected base station by a predefined distance during the predetermined time period t1 through t0, it is possible to determine that the mobile terminal maintains its moving status.

In order to determine the decrease in the strength of the signal transmitted from the currently-connected base station, results of sensing operations that have been previously performed with respect to signal strengths may be used. For example, a signal strength of a current base station is sensed at regular intervals by the mobile terminal, and by using a plurality of pieces of information regarding signal strengths that have been previously sensed before the mobile terminal is determined to be in the moving status, it is possible to determine whether the signal strength of the current base station is continually decreased. For example, an average value of the signal strengths based on the sensing results may be calculated, and the decrease in the signal strength of the current base station may be determined by comparing the calculated average value with a result of a signal strength sensing operation performed after the mobile terminal is determined to be in the moving status.

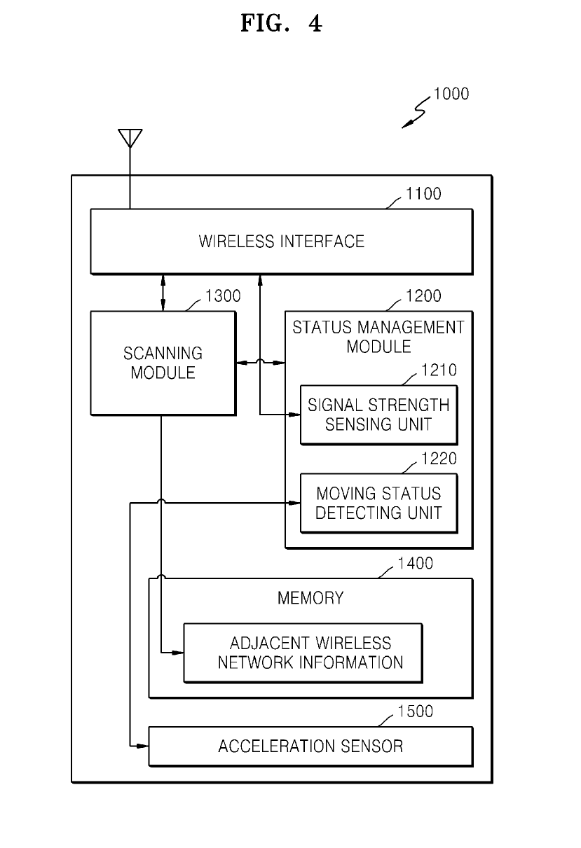

FIG. 4 is a block diagram of a mobile terminal 1000 included in a wireless network system, according to an embodiment of the present invention. As illustrated in FIG. 4, the mobile terminal 1000 may include a wireless interface 1100, a status management module 1200, a scanning module 1300, a memory 1400, and an acceleration sensor 1500. The status management module 1200 may include a signal strength sensing unit 1210 and a moving status detecting unit 1220 so as to sense a received signal strength indication (RSSI) of a signal transmitted from a base station and to detect a moving status of the mobile terminal 1000. Also, the memory 1400 may store various types of information such as system data required to operate the mobile terminal 1000, general data such as multimedia data, or a plurality of pieces of information regarding adjacent wireless networks for a wireless network access.

When the mobile terminal 1000 accesses a base station based on the standard protocol according to each wireless network type, the wireless interface 1100 actually performs data communication by transmitting and receiving a wireless signal. The scanning module 1300 performs a scanning operation for each available channel according to conditions presented by one or more embodiments of the present invention, collects information (e.g., base station information) regarding wireless networks around the mobile terminal 1000, and stores the information in the memory 1400. If the aforementioned conditions are not satisfied, the scanning module 1300 does not perform the scanning operation, so that power consumption of the mobile terminal 1000 may be decreased.

The status management module 1200 determines whether the mobile terminal 1000 is in a still status or a moving status, senses a signal strength of a signal from a currently-connected base station, and determines whether the signal strength is in an increasing status or a decreasing status. The moving status detecting unit 1220 receives a value of each axis of the acceleration sensor 1500 mounted in the mobile terminal 1000, and then determines whether the mobile terminal 1000 is in the still status or the moving status. The signal strength sensing unit 1210 senses a signal strength of a signal transmitted from a base station connected via the wireless interface 1100, analyzes an increase and decrease pattern of the signal strength, and determines whether the signal strength is equal to or less than a predetermined threshold value. As described above, the moving status detecting unit 1220 determines the still status or the moving status of the mobile terminal 1000 by recognizing a variation pattern of the value of each axis of the acceleration sensor 1500. FIG. 4 illustrates an example in which the acceleration sensor 1500 is applied to detect the moving status of the mobile terminal 1000. However, one or more embodiments of the present invention are not limited thereto, and thus, one of other sensors capable of detecting mobility of a user or the mobile terminal 1000 may be used.

Hereinafter, detailed operations of the mobile terminal 1000 having the aforementioned structure will be described.

As described above, the scanning module 1300 selectively performs the scanning operation according to sensing results by the status management module 1200.

The sensing result with respect to the signal strength, and the sensing result with respect to a user status (e.g., the moving status of the mobile terminal 1000 of the user), which are performed by the status management module 1200, are provided to the scanning module 1300, and then the scanning module 1300 performs the scanning operation only when the sensing results satisfy predetermined conditions. A plurality of pieces of information regarding adjacent base stations which are obtained via the scanning operation by the scanning module 1300 are stored in the memory 1400, and the information regarding the adjacent base stations stored in the memory 1400 may be used in a handoff process for an access to another base station.

When a user moves while carrying the mobile terminal 1000, a status of the mobile terminal 1000 is changed from the still status to the moving status, and the moving status detecting unit 1220 detects the status change by using a signal from the acceleration sensor 1500. Also, the moving status detecting unit 1220 monitors the signal from the acceleration sensor 1500 during a predetermined time period and then determines whether the moving status of the mobile terminal 1000 is maintained during the predetermined time period. The detection result with respect to the status change, and the determination result with respect to the maintenance of the moving status during the predetermined time period are provided to the scanning module 1300.

Although mobility occurs in the mobile terminal 1000, it is necessary to selectively perform the scanning operation according to whether the mobile terminal 1000 moves toward the currently-connected base station or becomes distant from the currently-connected base station. For example, although the moving status of the mobile terminal 1000 is maintained during the predetermined time period, when the mobility of the mobile terminal 1000 is not in a direction where a signal strength of a signal from the currently-connected base station is decreased, it is not necessary to perform the scanning operation. Accordingly, the signal strength sensing unit 1210 senses the signal strength from the currently-connected base station and determines if an increase and decrease pattern of the signal strength occurred.

In more detail, the signal strength sensing unit 1210 may sense a strength of a received signal, may determine whether the strength of the received signal is less than the predetermined threshold value, or may analyze an increase and decrease pattern of the strength of the received signal. The sensing and analysis results are provided to the scanning module 1300, and then the scanning module 1300 selectively performs the scanning operation by using information regarding the moving status of the mobile terminal 1000, and information regarding the strength of the received signal.

Hereinafter, the selective scanning operation in the present embodiment will be described.

In the scanning operation, information regarding accessible base stations around the mobile terminal 1000 may be first scanned, the information may be stored in the memory 1400, and a handoff process may be performed by using the information stored in the memory 1400 so as to actually connect the mobile terminal 1000 to another base station.

First, when the moving status of the mobile terminal 1000 is detected according to the signal from the acceleration sensor 1500, the moving status detecting unit 1220 determines whether the moving status is maintained during a predetermined time period. Also, when the moving status of the mobile terminal 1000 is detected, the moving status detecting unit 1220 senses a signal strength of a signal from the currently-connected base station, and determines whether the signal strength keeps decreasing. The predetermined time period used to determine whether the moving status of the mobile terminal 1000 is maintained may be equal to a predetermined time period used to determine whether the signal strength keeps decreasing

As a result of the determination, when the moving status of the mobile terminal 1000 is maintained during the predetermined time period, and simultaneously, the signal strength of the signal from the currently-connected base station keeps decreasing, the scanning module 1300 performs the scanning operation so as to search for adjacent base stations and stores information in the memory 1400, wherein the information is related to the adjacent base stations which is obtained via the scanning operation. The stored information regarding the adjacent base stations may be used in the handoff process to be followed.

Also, according to another embodiment of the present invention, conditions of the moving status and the signal strength which are for the scanning operation and the handoff process may vary. For example, while the moving status of the mobile terminal 1000 is maintained, the signal strength sensing unit 1210 determines whether the signal strength of the signal from the currently-connected base station is less than the predetermined threshold value. As a result of the determination, when the signal strength is less than the predetermined threshold value, the scanning module 1300 performs a scanning operation so as to search for adjacent base stations and stores information in the memory 1400, wherein the information is related to the adjacent base stations identified via the scanning operation. The stored information regarding the adjacent base stations may be used in the handoff process to be followed.

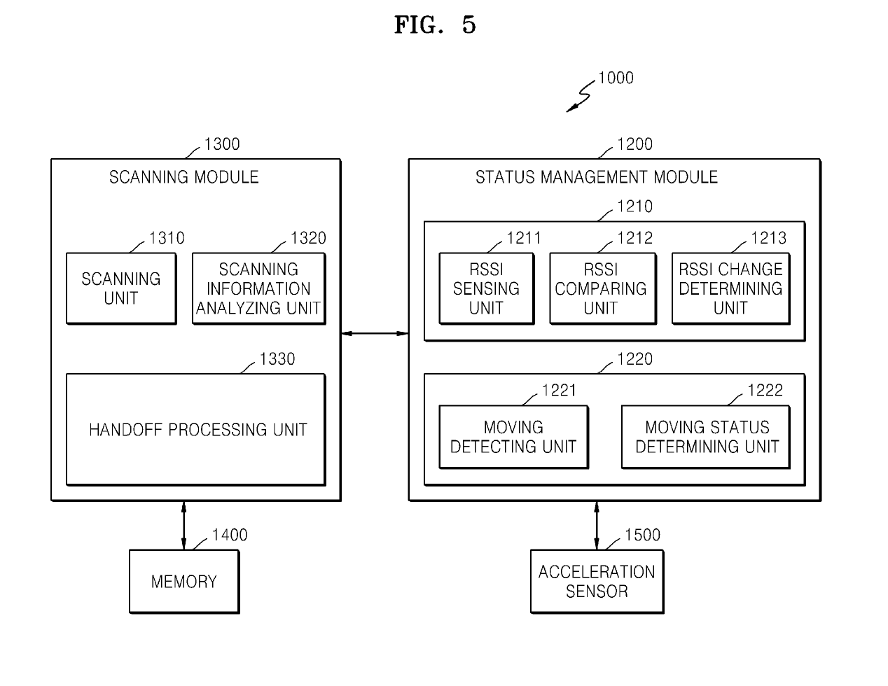

FIG. 5 is a block diagram illustrating a detailed structure of the mobile terminal 1000 of FIG. 4. As illustrated in FIG. 5, the mobile terminal 1000 may include the status management module 1200 and the scanning module 1300, and the status management module 1200 may include the signal strength sensing unit 1210 and the moving status detecting unit 1220. Also, the signal strength sensing unit 1210 may include an RSSI sensing unit 1211, an RSSI comparing unit 1212, and an RSSI change determining unit 1213, and the moving status detecting unit 1220 may include a moving detecting unit 1221 and a moving status determining unit 1222. Also, the scanning module 1300 may include a scanning unit 1310, a scanning information analyzing unit 1320, and a handoff processing unit 1330. The memory 1400 to store a scanning result of the scanning module 1300, and the acceleration sensor 1500 to monitor a moving status of the mobile terminal 1000 are further illustrated in FIG. 5, and for convenience of description, other elements of the mobile terminal 1000 are omitted.

The RSSI sensing unit 1211 senses a signal strength of a signal from a currently-connected base station, and the RSSI comparing unit 1212 compares the sensed signal strength with a threshold value. The threshold value is a reference value for determination of whether to perform the handoff process, and when the signal strength from the currently-connected base station is less than threshold value, the handoff process is performed to access adjacent other base stations. The RSSI change determining unit 1213 determines whether the sensed signal strength has an increase pattern or a decrease pattern during a predetermined time period. The sensing and determination results of the signal strength sensing unit 1210 are provided to the scanning module 1300, and the scanning module 1300 performs a scanning operation by using the sensing and determination results.

The moving detecting unit 1221 detects whether a status of the mobile terminal 1000 is changed from a still status to the moving status, by using a signal from the acceleration sensor 1500. Also, the moving status determining unit 1222 determines whether the moving status of the mobile terminal 1000 is maintained during the predetermined time period, by using the detection result, and generates a determination result. The detection result and/or the determination result is provided to the scanning module 1300, and the scanning module 1300 performs the scanning operation by using detection result and the determination result.

The scanning unit 1310 selectively performs the scanning operation, in consideration of various result signals from the signal strength sensing unit 1210 and the moving status detecting unit 1220. The scanning information analyzing unit 1320 refers to a scanning result in order to select a base station on which a handoff process is performed. For example, when information regarding a base station is received via a channel, the information may include information regarding unexpected another base station. Accordingly, the scanning information analyzing unit 1320 may exclude the information regarding the unexpected another base station, may an RSSI value for each of expected base stations, and may select a base station having the greatest RSSI value from among the calculated values The handoff processing unit 1330 actually performs the handoff process on the selected base station. The handoff process may include an authentication process and a re-association process.

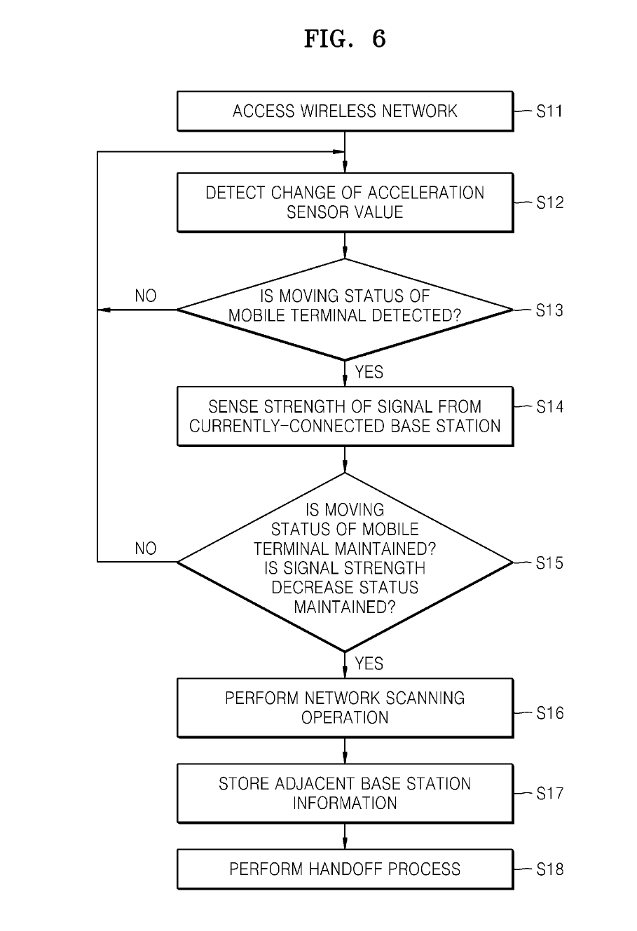

FIG. 6 is a flowchart of a scanning method performed by a wireless network system, according to an embodiment of the present invention. As illustrated in FIG. 6, a mobile terminal having an acceleration sensor mounted therein is connected to a base station of a wireless network and then enters a wireless network connection status (operation S11). A moving status detecting unit included in a status management module of the mobile terminal constantly detects a change of a signal from the acceleration sensor (operation S12). Also, according to the detection operation, it is determined whether a status of the mobile terminal is changed from a still status to a moving status (operation S13). As a result of the determination, when the moving status of the mobile terminal is not detected, the change of the signal from the acceleration sensor is constantly detected, and when the moving status of the mobile terminal is detected, a signal strength of a currently-connected base station is sensed (operation S14).

When the moving status of the mobile terminal of a user is detected, it is determined whether the moving status of the mobile terminal is maintained during a predetermined time period, and whether the signal strength of the currently-connected base station keeps a decreasing pattern during the predetermined time period (operation S14). As results of the determination, when at least one of the results of the determination is not satisfied, a scanning operation is not performed. On the other hand, when a condition related to movement of the mobile terminal, and a condition related to the signal strength of the currently-connected base station are all satisfied, the scanning operation is performed to search for a network (operation S16). A plurality of pieces of information regarding adjacent base stations, which are obtained via the scanning operation, are stored in a memory in the mobile terminal (operation S17), and a handoff processing operation is performed by using the information regarding the adjacent base stations, which are obtained via the scanning operation (operation S18).

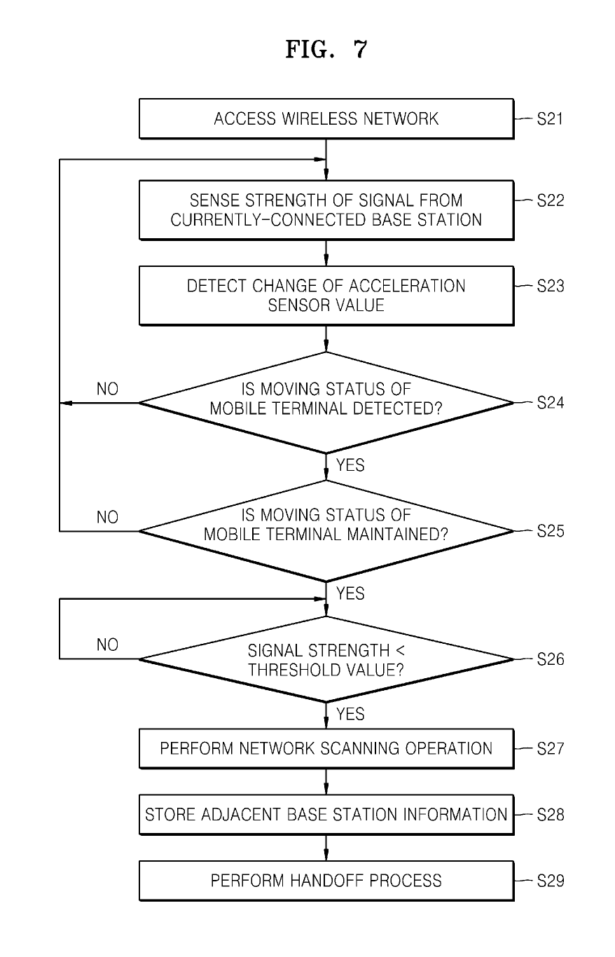

FIG. 7 is a flowchart of a scanning method performed by a wireless network system, according to another embodiment of the present invention. As illustrated in FIG. 7, a mobile terminal having an acceleration sensor mounted therein is connected to a base station of a wireless network and then enters a wireless network connection status (operation S21). Also, an operation is performed to sense a signal strength of a signal from a currently-connected base station (operation S22), and a moving status detecting unit included in a status management module of the mobile terminal constantly detects a change in a value of a signal from the acceleration sensor (operation S23).

As a result of the detection with respect to the change in the value of the signal from the acceleration sensor, a moving status of the mobile terminal is detected (operation S24). When a status of the mobile terminal is in a still status, the change in the value of the signal from the acceleration sensor is constantly detected, and when the moving status of the mobile terminal is detected, it is determined whether the moving status of the mobile terminal is maintained during a predetermined time period (operation S25). As a result of the determination, when the moving status of the mobile terminal is not maintained, it is determined that a scanning operation is not required to be performed, and thus the change in the value of the signal from the acceleration sensor is constantly detected. On the other hand, when it is determined that the moving status of the mobile terminal is maintained during the predetermined time period, it is determined whether the signal strength is less than a threshold value (operation S26).

As a result of the determination, when the signal strength is equal to or greater than the threshold value, the signal strength is constantly compared with the threshold value. On the other hand, when the signal strength is less than the threshold value, a scanning operation is performed to search for a network (operation S27). A plurality of pieces of information regarding adjacent base stations, which are obtained via the scanning operation, are stored in a memory in the mobile terminal (operation S28), and a handoff processing operation is performed by using the information regarding the adjacent base stations, which are obtained via the scanning operation (operation S29).

In the flowcharts of FIGS. 6 and 7, for convenience of description, an operation to detect the moving status of the mobile terminal, and an operation to sense the signal strength of the currently-connected base station are sequentially performed, but one or more embodiments of the present invention are not limited thereto. That is, the operation to determine the moving status of the mobile terminal by using the signal value of the acceleration sensor, and the operation to sense the signal strength of the currently-connected base station may be simultaneously performed, and the scanning operation may be selectively performed based on results of the moving status detecting operation and the signal strength sensing operation. Also, a network scanning operation to store the information regarding the adjacent base stations may be periodically performed or may be repeatedly performed according a predetermined condition. One of a condition for the scanning operation to store the information regarding the adjacent base stations and a condition for the scanning operation to perform the handoff process may be commonly used in one or more embodiments of the present invention, or the conditions may be separately performed in different embodiments.

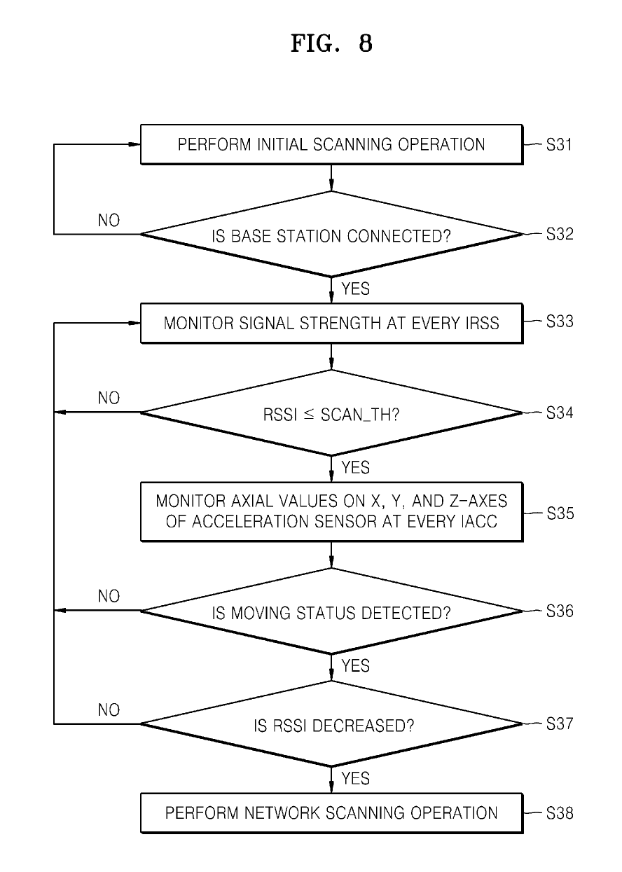

FIG. 8 is a flowchart of a scanning method performed by a wireless network system, according to another embodiment of the present invention. As illustrated in FIG. 8, when initialization is performed by supplying power to a mobile terminal, an initial scanning operation is performed (operation S31). A base station connecting operation is performed according to the initial scanning operation (operation S32), and when a base station is not connected, the initial scanning operation is re-performed.

When the base station is connected, the mobile terminal monitors a signal strength RSSI of a signal from a currently-connected base station at every first period Iᵣₛₛ (operation S33). When the signal strength RSSI is detected, the signal strength RSSI is compared with a threshold value SCAN_TH, and it is determined whether a value of the signal strength RSSI is less than the threshold value SCAN_TH or is equal to or less than the threshold value SCAN_TH (operation S34).

As a result of the determination, when the signal strength RSSI is greater than the threshold value SCAN_TH, the signal strength RSSI is constantly sensed, and when the signal strength RSSI is equal to or less than the threshold value SCAN_TH, values of X, Y, and Z-axes of an acceleration sensor mounted in the mobile terminal are monitored at every second period I_{acc}(operation S35). The acceleration sensor may constantly sense and output the values of the X, Y, and Z-axes while the mobile terminal operates, and in a monitoring operation with respect to the values of the X, Y, and Z-axes, the values of the X, Y, and Z-axes which are sensed and output by the acceleration sensor may be sampled and processed at every second period I_{acc}. For example, as described above, standard deviation values or variance values may be calculated by using the sampled axial values on the X, Y, and Z-axes, and the calculated standard deviation values or variance values may be summed and a value of the sum may be compared with a threshold value. Because the monitoring operation with respect to the axial values on the X, Y, and Z-axes is performed only when the signal strength RSSI is equal to or less than the threshold value SCAN_TH, resources such as a central processing unit (CPU), a random-access memory (RAM), a power, and the like that are used for a computation operation may be saved.

A moving status of the mobile terminal may be detected according to the monitoring result (operation S36). When the mobile terminal is in a still status, the signal strength RSSI of the signal from the currently-connected base station is monitored again at every first period Iᵣₛₛ (operation S36). However, when the mobile terminal is in the moving status, it is determined whether the signal strength RSSI of the signal from the currently-connected base station keeps decreasing (operation S37). The decrease of the signal strength RSSI may be determined by comparing the signal strength RSSI with an average value of a plurality of signal strengths RSSI that have been previously sensed. In more detail, the average value of a plurality of signal strengths RSSI that have been sensed before the moving status of the mobile terminal is detected may be calculated, and after the moving status of the mobile terminal is detected, the sensed signal strength RSSI may be compared with the average value.

As a result of the comparison, when it is determined that the signal strength RSSI is not decreased, the signal strength RSSI of the signal from the currently-connected base station is monitored again at every first period Iᵣₛₛ. However, when it is determined that the signal strength RSSI keeps decreasing, a network scanning operation is performed (operation S38).

According to the mobile terminal and the wireless network system including the mobile terminal of the one or more embodiments of the present invention, a wireless network scanning operation is adaptively performed according to mobility of a user or the mobile terminal, so that an overhead of a wireless network is decreased while a network detection function is maintained, and thus, a usage rate of a network bandwidth with respect to actual data communication may be improved.

Also, according to the mobile terminal and the wireless network system including the mobile terminal of the one or more embodiments of the present invention, because information of the acceleration sensor that uses a small amount of power is used, unnecessary wireless network scanning attempts that consume a large amount of power are decreased, so that power consumption of the mobile terminal may be decreased.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A scanning method performed by a wireless network system comprising a mobile terminal, the scanning method comprising:
detecting a moving status of the mobile terminal by using a value of a signal from a sensor that is mounted in the mobile terminal;
determining whether the moving status of the mobile terminal is maintained during a first time period after the moving status is detected;
sensing a strength of a signal provided from a base station to which the mobile terminal is connected; and
performing a scanning operation according to a result of the determining and a result of the sensing.

2. The scanning method of claim 1, further comprising determining whether a decrease status of the strength of the signal provided from the base station is maintained during the first time period, and
when it is determined that the moving status of the mobile terminal is maintained and simultaneously it is determined that the decrease status of the strength of the signal provided from the base station is maintained during the first time period, performing the scanning operation.

3. The scanning method of claim 1, wherein the determining of the moving status comprises determining whether the mobile terminal becomes distant from the base station, based on the sensing of the strength of the signal provided from the base station, and when the mobile terminal becomes distant from the base station, the scanning operation is performed.

4. The scanning method of claim 1, further comprising:
storing information regarding a result of the scanning operation in a memory in the mobile terminal;
comparing the strength of the signal provided from the base station with a threshold value; and
performing a handoff process with respect to other base station, according to a comparison result.

5. The scanning method of claim 4, wherein the handoff process is performed when the moving status of the mobile terminal is maintained and simultaneously the strength of the signal is less than the threshold value.

6. A mobile terminal comprising:
a sensor for generating a signal corresponding to movement of the mobile terminal;
a status management module for detecting a moving status of the mobile terminal by using the signal from the sensor, and for sensing a strength of a signal provided from a base station to which the mobile terminal is connected;
a scanning module for performing a scanning operation with respect to adjacent base stations according to a result of the detecting and a result of the sensing; and
a memory for storing information collected via the scanning operation.

7. The mobile terminal of claim 6, wherein the status management module comprises:
a signal strength sensing unit for sensing the strength of the signal provided from the base station, and for determining an increase and decrease pattern of the strength of the signal provided from the base station; and
a moving status detecting unit for detecting a moving status of the mobile terminal by using the signal from the sensor, and for determining whether the moving status of the mobile terminal is maintained.

8. The mobile terminal of claim 6, wherein the scanning module performs the scanning operation when the moving status of the mobile terminal is maintained during a first time period and simultaneously, a decrease status of the strength of the signal provided from the base station is maintained, after the moving status is detected.

9. The mobile terminal of claim 6, wherein the status management module compares the strength of the signal provided from the base station with a threshold value, and then generates a comparison result; and
the scanning module performs a handoff process with respect to other base station, according to the comparison result.

10. The mobile terminal of claim 9, wherein the handoff process is performed when the moving status of the mobile terminal is maintained and simultaneously the strength of the signal is less than the threshold value.

11. The mobile terminal of claim 6, wherein the sensor comprises an acceleration sensor.

12. A wireless network system comprising the mobile terminal of claim 6.
